(19) United States
(12) Patent Application Publication
(10) Pub. No.: US 2014/0177796 A1
(43) Pub. Date: Jun. 26, 2014

(54) X-RAY TUBE

(71) Applicants: Yasue Sato, Machida-shi (JP); Takao Ogura, Yokohama-shi (JP); Kazuyuki Ueda, Tokyo (JP); Shuji Aoki, Yokohama-shi (JP); Ichiro Nomura, Atsugi-shi (JP); Miki Tamura, Kawasaki-shi (JP); Yoshihiro Yanagisawa, Fujisawa-shi (JP); Koji Yamazaki, Ayase-shi (JP)

(72) Inventors: Yasue Sato, Machida-shi (JP); Takao Ogura, Yokohama-shi (JP); Kazuyuki Ueda, Tokyo (JP); Shuji Aoki, Yokohama-shi (JP); Ichiro Nomura, Atsugi-shi (JP); Miki Tamura, Kawasaki-shi (JP); Yoshihiro Yanagisawa, Fujisawa-shi (JP); Koji Yamazaki, Ayase-shi (JP)

(73) Assignee: CANON KABUSHIKI KAISHA, Tokyo (JP)

(21) Appl. No.: 14/123,878

(22) PCT Filed: May 28, 2012
(86) PCT No.: PCT/JP2012/003471

§ 371 Date: Feb. 7, 2014

(30) Foreign Application Priority Data
Jun. 7, 2011 (JP) 2011-127440

(51) Int. Cl. H01J 35/16; G01N 23/04

(52) U.S. Cl. CPC H01J 35/16; G01N 23/04
USPC 378/62; 378/123; 378/122

(57) ABSTRACT

In an X-ray tube having an X-ray shielding member allowing an electron ray to pass through an electron passing hole toward a target, separately from the cathode-side opening of the electron passing hole, a gas exhaust path allowing communication between the inside and outside of the electron passing hole is provided so that gas molecules generated in the electron passing hole can be easily diffused out of the electron passing hole. The degradation of the cathode caused by accelerated collisions with the cathode, of cations generated by collisions of electrons with gas molecules generated in the electron passing hole by a desorption phenomenon due to electron ray irradiation to the target, is reduced.

### TECHNICAL FIELD

The present invention relates to an X-ray tube that is a main part of an X-ray generating unit used in an X-ray photographing apparatus used for medical purposes or non-destructive testing.

### BACKGROUND ART

In general, an X-ray tube generates X-rays by controlling the orbits of electrons emitted from a cathode, with a control electrode, then accelerating the electrons with a positive voltage applied between an anode and the cathode, and causing the electrons to collide with a target placed on the anode. Generated X-rays are applied to a subject through an X-ray window.

By placing an X-ray shielding member (X-ray/reflection electron shielding unit) on the cathode side of a target of an X-ray tube, unwanted X-rays and reflection electrons can be blocked, and heat dissipating characteristics can be improved (see PTL 1).

Collisions of electrons with the target heat the anode, and molecules of residual gas are emitted from the anode. Collisions of electrons with gas molecules positively ionize the gas molecules. These cations are accelerated opposite to electrons toward the cathode, impact the cathode, and damage the cathode (see PTL 2).

### CITATION LIST

### Patent Literature

PTL 1: Japanese Patent Laid-Open No. 2009-205992

PTL 2: PCT Japanese Translation Patent Publication No. 2005-523558

### SUMMARY OF INVENTION

### Technical Problem

In the case where as a component of an X-ray tube, an X-ray shielding member that is disposed so as to surround a surface of a target facing a cathode and allows an electron ray to pass through an electron passing hole toward the target is provided, gas molecules generated from the target tend to accumulate in the electron passing hole of the X-ray shielding member. Gas molecules accumulated in the electron passing hole are positively ionized by electrons passing through the electron passing hole, are accelerated toward the cathode, and collide with the cathode. The collisions of ions damage the cathode, reduce the electron emission efficiency, reduce the anodic current, and finally reduce the amount of generated X-rays.

The present invention extends the life of an X-ray tube having an X-ray shielding member. More specifically, the present invention reduces the degradation of a cathode caused by accelerated collisions with the cathode, of cations derived from gas molecules generated in an electron passing hole from a target.

### Solution to Problem

In an aspect of the present invention, an X-ray tube includes a cathode emitting electrons, an anode accelerating emitted electrons, a target with which accelerated electrons collide and thereby generate X-rays, and an X-ray shielding member disposed so as to surround a surface of the target facing the cathode, and allowing the electrons to pass through an electron passing hole toward the target. Separately from an opening of the electron passing hole facing the cathode, the X-ray tube has a gas exhaust path allowing communication between the inside and outside of the electron passing hole.

### Advantageous Effects of Invention

According to the present invention, gas molecules generated from the target by collisions of electrons can be rapidly diffused and discharged through the gas exhaust path to the outside of the electron passing hole. As a result, the number of cations generated by collisions with electrons passing through the electron passing hole can be reduced. Thus, the degradation of the cathode due to collisions of cations is reduced, and the anodic current can be stabilized over a long period of time.

### BRIEF DESCRIPTION OF DRAWINGS

FIG. 1A is a schematic sectional view of a whole X-ray tube according to a first embodiment of the present invention.

FIG. 1B is a schematic enlarged sectional view of the X-ray shielding member and its vicinity in FIG. 1A.

FIG. 1C is a perspective view of the X-ray shielding member.

FIG. 2 is a schematic enlarged sectional view of an X-ray shielding member and its vicinity showing an X-ray tube according to a second embodiment of the present invention.

FIG. 3 is a schematic sectional view of a Spindt-type cold cathode according to the present invention.

FIG. 4 is a block diagram of an X-ray photographing apparatus according to the present invention.

### DESCRIPTION OF EMBODIMENTS

The embodiments of the present invention will now be described with reference to the drawings, in which like reference signs refer to like components.

### First Embodiment

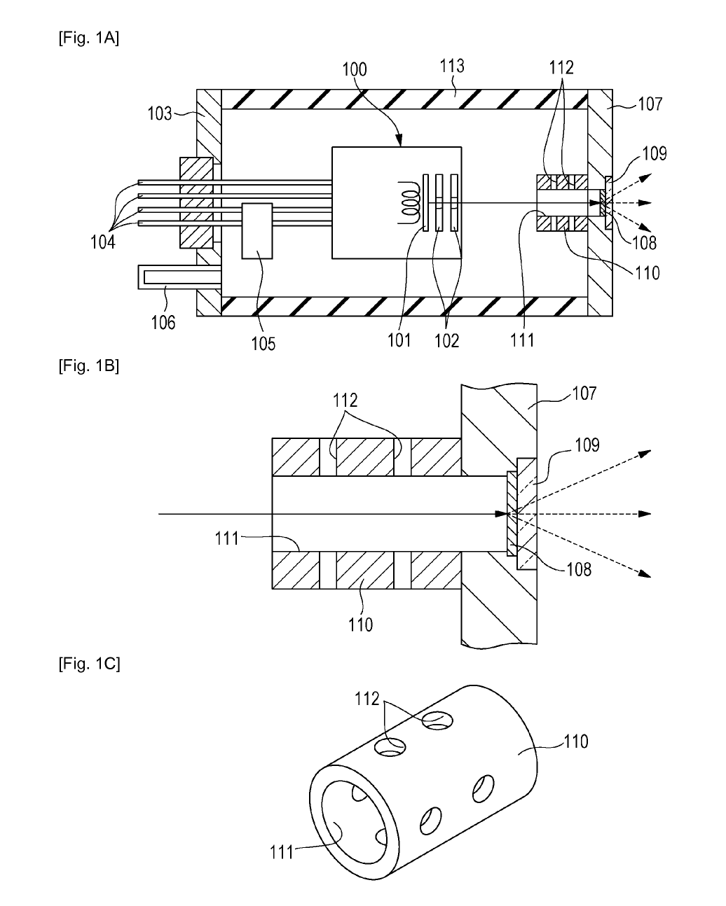

As shown in FIGS. 1A to 1C, an X-ray tube according to a first embodiment has an electron gun 100 that controls electrons emitted from a cathode 101 with control electrodes 102 and generates an electron beam having a predetermined orbit and size. A filament cathode made of a high melting point metal such as tungsten or rhenium or made by applying yttria or the like to the surface of such a metal, a thermal field emission cathode, r an impregnated cathode made by impregnating porous tungsten mostly with barium can be used as the cathode 101. A cold cathode such as a Spindt-type cathode, a carbon nanotube cathode, or a surface conduction cathode can also be used. A current heating the cathode 101 and a control signal are introduced into the electron gun 100 through current/voltage introducing conductors 104. The electron gun 100 is mechanically fixed to an electron gun flange 103 with a hermetically sealed insulating member made of ceramics or the like therebetween. In the electron gun flange 103, a gas exhaust pipe 106 for discharging air in the X-ray tube at the time of manufacturing, and a getter 105 evacuating the inside are placed. An evaporable getter made of barium or the like, or a non-evaporable getter made of an alloy of zirconium, titanium, vanadium, iron, aluminum, and others can be used as the getter 105. In the figure, the solid arrow heading from the electron gun 100 toward the target 108 (described later) denotes an electron ray, and the dashed arrows heading from the X-ray window 109 (described later) toward the outside denote X-rays.

An anode 107 is disposed opposite the cathode 101 of the electron gun 100. The anode 107 is made of metal. Kovar is suitable as a material for the anode 107 from a viewpoint of vacuum-tight joining to the adjacent member. In order to accelerate electrons, a positive voltage of 30 kV to 150 kV relative to the cathode 101 is applied to the anode 107 from the outside. The anode 107 and the electron gun flange 103 are separated by a cylindrical insulator 113, and electrical insulation is maintained. The anode 107 and the electron gun flange 103 are vacuum-tightly joined to the insulator 113, and the anode 107, the electron gun flange 103, and the insulator 113 form a vacuum-tight envelope. Ceramics such as alumina or glass is suitable as a material for the insulator 113. Silver brazing after the metalizing of the insulator 113 can be used as a vacuum-tight joining method. Alternatively, the anode 107 and the electron gun flange 103 may be divided, and after the silver brazing of the divided anode 107 and electron gun flange 103 to the insulator 113, vacuum-tight welding may be performed in the divided parts.

An X-ray window 109 that transmits X-rays is vacuum-tightly joined to part of the anode 107 so as to cover a window hole formed in the anode 107. A target 108 is placed on a surface of the X-ray window 109 facing the cathode 101. An electron beam emitted from the electron gun 100 collides with the target 108 placed on the X-ray window 109 and radiates part of energy as X-rays. The generated X-rays are radiated through the X-ray window 109 to the outside of the X-ray generating unit. Materials for the X-ray window 109 include diamond, silicon carbide, aluminum, and beryllium.

The target 108 is in electrical communication with the anode 107. Materials suitable for the target 108 include tungsten, copper, tantalum, platinum, molybdenum, tellurium, and alloys thereof. The present invention is useful for a transmission type X-ray unit in which X-rays are emitted outward from a surface of target 108 opposite the electron collision surface.

An X-ray shielding member 110 is placed so as to surround the side of the target 108 facing the cathode 101. The X-ray shielding member 110 is made of a metal such as tungsten, copper, or tantalum and absorbs unwanted X-rays radiated from the target 108 in a direction opposite to electrons. The X-ray shielding member 110 is a tubular member having an electron passing hole 111 that allows an electron ray to pass through it toward the target 108. As through-holes penetrating the peripheral wall of the X-ray shielding member 110, gas exhaust paths 112 are formed. Separately from the cathode-side opening of the electron passing hole 111, the gas exhaust paths 112 allow communication between the inside and outside of the electron passing hole 111. The through-holes formed as gas exhaust paths 112 can be formed such that all straight lines passing through the through-holes from the position of collision of electrons with the target 108 intersect with the inner wall surfaces of the through-holes. By forming through-holes as gas exhaust paths 112 in such a manner, unwanted X-rays and reflection electrons can be prevented from leaking through the gas exhaust paths 112 out of the X-ray shielding member 110.

In the above-described X-ray tube, an electron ray generated by the electron gun 100 is accelerated by a voltage applied to the anode 107 and is caused to collide with the target 108, and desired X-rays are radiated. At the same time, by a desorption phenomenon due to electron irradiation, gas is emitted from the target 108 to the space of the electron passing hole 111. This gas is diffused and discharged through the gas exhaust paths 112 from the space of the electron passing hole 111 to the outside. Thus, the pressure in the electron passing hole 111 decreases compared to the case where the X-ray shielding member 110 does not have the gas exhaust paths 112. Even if the diameter of the gas exhaust paths 112 is small, the pressure in the space of the electron passing hole 111 can be reduced accordingly. However, the gas exhaust paths 112 desirably have such a diameter that compared to the conductance (coefficient showing the flowability of gas) of the electron passing hole 111, the conductance of the gas exhaust paths 112 is about more than half. By providing the gas exhaust paths 112, the pressure in the electron passing hole 111 is reduced, and the number of cations generated by collisions with electrons traveling in the electron passing hole 111 is also reduced. Cations are accelerated by a positive voltage applied to the anode 107 in a direction opposite to electrons toward the cathode 101 and finally collide with the cathode 101. Of course the number of cations that collide with the cathode 101 is also reduced. As a result, the damage of the cathode 101 due to collisions of cations is reduced, the decrease in electron emission efficiency can be suppressed, the electrons forming an electron beam, that is, the anodic current does not decrease, and the amount of finally radiated X-rays does not decrease and is maintained over a long period of time. Generated gas is finally adsorbed and removed by the getter 105.

At least the inner wall surface of the electron passing hole 111 of the X-ray shielding member 110 can be made of a conductive material, and the inner wall surface can be controlled at the same potential as the anode 107. The X-ray shielding member 110 of this embodiment is a conductive member made of metal and is electrically connected to the anode 107. Thus, the whole of the X-ray shielding member 110 is at the same potential as the anode 107. When the inner wall surface of the electron passing hole 111 is at the same potential as the anode 107, the electric field in the electron passing hole 111 can be rendered equal to zero. For this reason, cations generated in the electron passing hole 111 as described above are not accelerated in any direction. Even in the case where cations generated in the electron passing hole 111 collide with the cathode 101, the cations are caused to exit the electron passing hole 111 and to collide with the cathode 101 only by diffusion. Thus, the damage of the cathode 101 can be significantly reduced. At least the inner wall surface of the X-ray shielding member 110 and the anode 107 can be grounded. In this case, the above benefit can be easily obtained.

### Second Embodiment

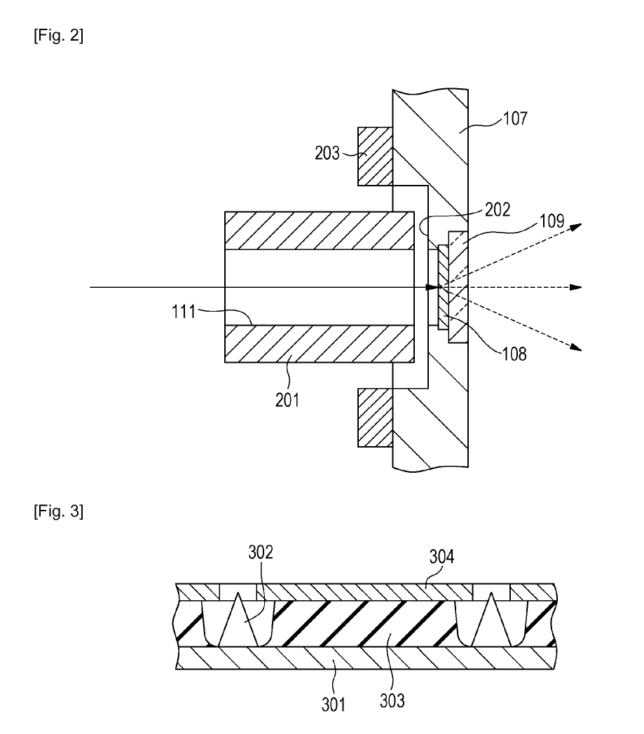

In FIG. 2, an X-ray shielding member 201 has, as in the first embodiment, an electron passing hole 111 that allows an electron ray to pass through it toward a target 108, and is formed of the same material for the X-ray shielding member 110 in the first embodiment. Unlike the first embodiment, the gas exhaust path 202 of the X-ray shielding member 201 in the second embodiment is not through-holes penetrating the peripheral wall of the X-ray shielding member 110 but a gap around an end of the X-ray shielding member 201 facing an anode 107. Specifically, a window hole having a diameter larger than the diameter of the X-ray shielding member 201 is formed in the anode 107, and a gap is formed between the end of the X-ray shielding member 201 facing the anode 107, and the anode 107 (and the target 108). This gap serves as a gas exhaust path 202 that allows the anode-side opening of the electron passing hole 111 to communicate with the outside of the electron passing hole 111.

Also in this embodiment, when an electron ray generated by an electron gun 100 (see FIG. 1A) is accelerated by applying a voltage to the anode 107 and is caused to collide with the target 108, and X-rays are generated, gas is emitted from the target 108 into the space of the electron passing hole 111 by an electron irradiation desorption phenomenon. This gas in this embodiment is discharged from the internal space of the electron passing hole 111 to the outside through the gas exhaust path 202 that is a gap between the target 108 (and the anode 107) and an end of the X-ray shielding member 201. In the same manner as described in the first embodiment, reduction of electrons emitted from the cathode 101 can be suppressed, and the amount of finally emitted X-rays can be maintained in a good state over a long period of time.

In this embodiment, an annular auxiliary X-ray shielding member 203 can be provided on part of the anode 107 around the X-ray shielding member 201 (around the window hole). As with the X-ray shielding member 201, the auxiliary X-ray shielding member 203 is made of a material that can absorb unwanted electrons and X-rays, such as tungsten, copper, or tantalum. By providing the auxiliary X-ray shielding member 203, leakage of unwanted X-rays and reflection electrons can be prevented even when the gap provided as the gas exhaust path 202 is widened.

The X-ray shielding member 201 can be supported, for example, with supports provided on the anode 107. By electrically connecting the anode 107 and the X-ray shielding member 201 through these supports, the inner wall surface of the electron passing hole 111 and the anode 107 can be brought to the same potential.

If an X-ray tube has both of the gas exhaust paths 112 in the first embodiment of

FIGS. 1A to 1C and the gas exhaust path 202 in the second embodiment of FIG. 2, the X-ray tube can discharge gas molecules in the electron passing hole 111 to the outside of the electron passing hole 111 more easily.

### Example 1

An X-ray tube having the configuration shown in FIGS. 1A to 1C was made as follows.

As a cathode 101, an impregnated cathode made by impregnating porous tungsten with a barium compound was used. An electron gun 100 was formed together with control electrodes 102 having openings of (phi) 2 mm. Current/voltage introducing conductors 104 and an electron gun flange 103 were made of Kovar. “ST172” manufactured by SAES getters S.p.A. was used as a getter 105. An anode 107 was made of Kovar. An X-ray window 109 having a thickness of 1 mm was made of diamond. As a target 108, a tungsten film having a thickness of 10 micrometers was formed by sputtering.

An X-ray shielding member 110 having a cylindrical shape of 10 mm (phi)*15 mm was made of tungsten. An electron passing hole 111 of 2 mm (phi) was formed in the center of the cylinder, and eight through-holes of 4 mm (phi) were formed as gas exhaust paths 112 in directions perpendicular to the axis of the cylinder. Any of the through-holes as gas exhaust paths 112 was formed at such a position and angle that the outer opening thereof was not directly visible from the central position of the target 108 that was the position of collision of electron ray. The conductance to the outer space in this example was two or more orders of magnitude larger than that in the case where the X-ray shielding member 110 does not have the gas exhaust paths 112.

The anode 107 and an insulator 113 were joined together by silver brazing and welding. Finally, the anode 107, the electron gun flange 103, and the insulator 113 formed a vacuum-tight envelope. A gas exhaust pipe 106 made of copper, of the above-described the X-ray tube was connected to an evacuating system (not shown), and then the whole X-ray tube was baked at 400 degree (Celsius) while being evacuated. After that, the getter 105 was energized and activated, and then the cathode 101 was activated Finally the gas exhaust pipe 106 was crimp-sealed, and an operable X-ray tube was made. After that, the electron gun 100 and the anode 107 of this X-ray tube were electrically connected to an external drive power source (not shown). Improvement in discharge pressure resistance and cooling with insulating oil were performed. A voltage of 80 kV was applied as an anodic voltage. Pulses of 5 ms pulse width at a frequency of 10 Hz were applied to the control electrodes 102. A current of 10 mA was applied to the anode 107. The change over time in the amount of X-rays was measured. As a result, 1000 hours later, the amount of X-rays decreased by 10% compared to the beginning, and the decrease ratio was less than the specification value.

### Comparison 1

As comparison 1, an X-ray tube employing an X-ray shielding member 110 that was the same as example 1 except that it did not have the gas exhaust paths 112 was made, and the change over time in the amount of X-rays generated under the same measurement conditions as example 1 was measured. As a result, 1000 hours later, the amount of X-rays decreased by 45% compared to the beginning, and the decrease ratio was large compared to example 1. This confirmed the advantageous effect of the present invention.

### Example 2

As example 2, an X-ray tube was made that was the same as example 1 except that it employed a Spindt-type cold cathode shown in FIG. 3 as a cathode 101 and had the structure of X-ray generating portion shown in FIG. 2. In FIG. 3, reference sign 301 denotes a substrate made of single-crystal silicon to which electrical conductivity was imparted by doping impurities. Emitters 302 that emitted electrons, were conical, and were made of molybdenum and an insulating layer 303 of silicon dioxide were formed on the substrate 301 by sputter film formation and lithography. A molybdenum gate 304 for generating an electric field necessary for field emission and control of electrons between it and the emitters 302 was formed on the insulating layer 303. The emitters 302 were equally spaced 10 micrometers apart in a grid within a range of 2 mm (phi). A cathode 101 (see FIG. 1A) of electron gun 100 was cut out of the substrate 301.

Referring to FIG. 2, an X-ray shielding member 201 having a cylindrical shape of 10 mm (phi)*15 mm was made. An electron passing hole 111 of 2 mm (phi) was formed in the center of the cylinder. The X-ray shielding member 201 was placed 3 mm away from the target 108. A circular recess 20 mm (phi) and 7 mm deep was formed in the anode 107 coaxially with the X-ray shielding member 201. By this circular recess, a gap as a gas exhaust path 202 was formed around an end of the X-ray shielding member 201 facing the anode 107. The conductance to the outer space in this example was two or more orders of magnitude larger than that in the case where the X-ray shielding member 110 does not have the gas exhaust path 202. The X-ray shielding member 201 was made of tungsten. Except as described above, the X-ray tube was made in the same manner as example 1. By performing evacuation and others, the X-ray tube was rendered operable. Pulses of 5 ms pulse width at a frequency of 10 Hz were applied to the gate electrode 304. A voltage of 10 mA was applied as an anodic current to the control electrodes 102. Except as described above, X-rays were generated under the same measurement conditions as example 1. The change over time in the amount of X-rays was measured. As a result, 1000 hours later, the amount of X-rays decreased by 10% compared to the beginning, and the decrease ratio was less than the specification value.

### Comparison 2

As comparison 2, an X-ray tube employing an X-ray shielding member 110 that was the same as example 2 except that one end of the X-ray shielding member 110 is in contact with the target 108 and there is no gap therebetween was made, and the change over time in the amount of X-rays generated under the same measurement conditions as example 2 was measured. As a result, 1000 hours later, the amount of X-rays decreased by 55% compared to the beginning, and the decrease ratio was large compared to example 2. This confirmed the advantageous effect of the present invention.

### Third Embodiment

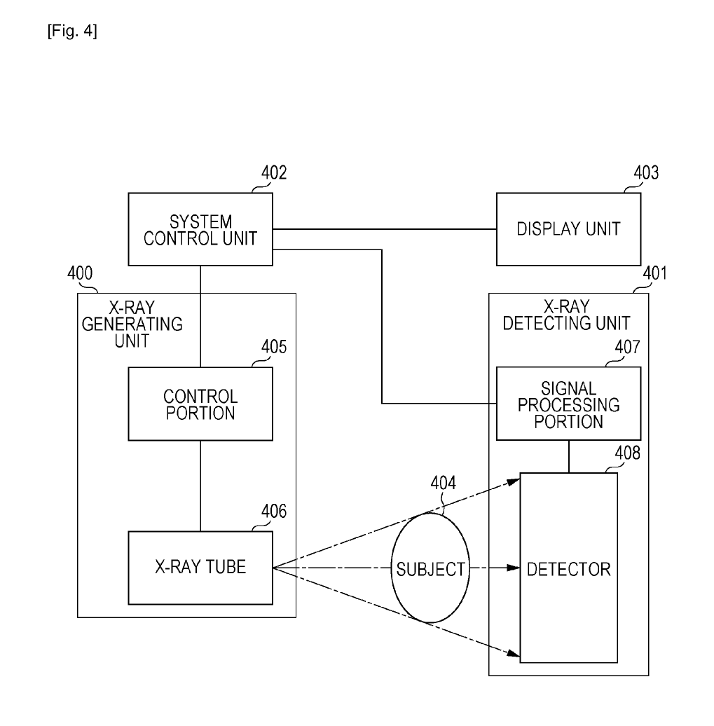

FIG. 4 is a block diagram of an X-ray photographing apparatus of the present invention. A system control unit 402 controls an X-ray generating unit 400 and an X-ray detecting unit 401 in a coordinated manner. Under the control of the system control unit 402, a control portion 405 outputs various control signals to an X-ray tube 406 described in any one of the above examples. By the control signals, the state of X-rays emitted from the X-ray generating unit 400 is controlled. X-rays emitted from the X-ray tube 406 pass through a subject 404 and are detected by a detector 408. The detector 408 converts the detected X-rays into an image signal and outputs the image signal to a signal processing portion 407. Under the control of the system control unit 402, the signal processing portion 407 processes the image signal and outputs the processed image signal to the system control unit 402. On the basis of the processed image signal, the system control unit 402 outputs a display signal for displaying an image on an display unit 403, to the display unit 403. The display unit 403 displays an image based on the display signal as a photographic image of the subject 404, on a screen.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-127440, filed Jun. 7, 2011, which is hereby incorporated by reference herein in its entirety.

### REFERENCE SIGNS LIST

100 Electron gun

101 Cathode

102 Control electrode

103 Electron gun flange

104 Current/voltage introducing conductor

105 Getter

106 Gas exhaust pipe

107 Anode

108 Target

109 X-ray window

110, 201 X-ray shielding member

111 Electron passing hole

112, 202 Gas exhaust path

203 Auxiliary X-ray shielding member

113 Insulator

301 Substrate

302 Emitter

303 Insulating layer

304 Gate

1. An X-ray tube comprising:
a cathode emitting electrons;
an anode accelerating emitted electrons;
a target with which accelerated electrons collide and thereby generate X-rays; and
an X-ray shielding member disposed so as to surround a surface of the target facing the cathode, and allowing the electrons to pass through an electron passing hole toward the target,
wherein separately from an opening of the electron passing hole facing the cathode, the X-ray tube has a gas exhaust path allowing communication between the inside and outside of the electron passing hole.

2. The X-ray tube according to claim 1, wherein as the gas exhaust path, a through-hole is formed in the X-ray shielding member.

3. The X-ray tube according to claim 2, wherein the through-hole is formed such that all straight lines imaginarily passing through the through-hole from the position of collision of electrons with the target intersect with the inner wall surface of the through-hole.

4. The X-ray tube according to claim 1, wherein as the gas exhaust path, a gap is formed around an end of the X-ray shielding member facing the anode.

5. The X-ray tube according to claim 4, wherein an auxiliary X-ray shielding member is provided on part of the anode around the X-ray shielding member.

6. The X-ray tube according to claim 1, wherein at least the inner wall surface of the electron passing hole is formed of a conductive material, and the inner wall surface can be controlled at the same potential as the anode.

7. The X-ray tube according to claim 6, wherein the inner wall surface of the X-ray shielding member and the anode are grounded.

8. The X-ray tube according to claim 1, wherein the X-ray tube is a transmission type X-ray tube in which the X-rays are emitted outward from a surface of the target opposite the electron collision surface.

9. The X-ray tube according to claim 1, wherein the cathode is a cold cathode.

10. An X-ray photographing apparatus comprising:
an X-ray tube comprising:
a cathode emitting electrons;
an anode accelerating emitted electrons;
a target with which accelerated electrons collide and thereby generate X-rays; and
an X-ray shielding member disposed so as to surround a surface of the target facing the cathode, and allowing the electrons to pass through an electron passing hole toward the target,
wherein separately from an opening of the electron passing hole facing the cathode, the X-ray tube has a gas exhaust path allowing communication between the inside and outside of the electron passing hole;
an X-ray detecting unit that detects X-rays emitted from the X-ray tube and passing through a subject; and
a control unit that controls the X-ray tube and the X-ray detecting unit in a coordinated manner.
